(19) United States
(12) Patent Application Publication
(10) Pub. No.: US 2016/0007795 A1
(43) Pub. Date: Jan. 14, 2016

(54) 3 IN 1 MINI COFFEE TUBE AS A CONTAINER, A FILTER, AND A STIRRING TOOL

(71) Applicants: YUEJIE ZHANG, FRANKFORT, IL (US); SHIFANG XU, FRANKFORT, IL (US)

(72) Inventors: YUEJIE ZHANG, FRANKFORT, IL (US); SHIFANG XU, FRANKFORT, IL (US)

(21) Appl. No.: 14/330,507

(22) Filed: Jul. 14, 2014

(51) Int. Cl. A47J 31/40

(52) U.S. Cl. CPC A47J 31/40

(57) ABSTRACT

Our single disposable mini coffee tube comprising a porous tube, a rolled filter, a top, and a bottom to form a complete container that has multiple functions of holding, filtering, and stirring in a standing posture in a cup of water or a coffee machine during a brewing process of coffee or tea. The appearance of the coffee tube is as slender as a pen or cigar. This 3 in 1 coffee tube, filter, and mixing tool creates a rigid handle that allows user to stir a strong water circulation for extracting more essences and. A short and strong brewing not only extract more essences and aroma as Espresso, but also reduce bitter. This disposable coffee tube will be pre-filled with ground coffee or tea, and sealed by wrapping foil as a single packaging for a single fresh service.

### CLAIM OF PRIORITY

This application claims priority of U.S. Provisional Patent Application 61/859,267 entitled A 3 IN 1 MINI COFFEE TUBE AS A CONTAINER, A FILTER AND A STIRRING TOOL, filed Jul. 28, 2013, the teaching of which are incorporated herein by reference.

### FIELD OF THE INVENTION

The present invention related to a small tube and a rolled filter for containing & filtering coffee ground in a cup filled with hot water during a coffee brewing process.

### BACKGROUND OF THE INVENTION

This relates to alternative of coffee bags alike that containing coffee grounds in water for brewing coffee beverage, specifically for brewing a single service coffee. This 3 in 1 mini coffee tube combines 3 functions of container, filter, and stirring tool. In a cup of water this coffee tube can be held and rotated by hand directly to produce a strong water circulation for extracting richer flavor efficiently than existed coffee bags.

After coffee roasting, oxidizing and losing aroma are key negative impacts in all of coffee making process of packaging, grinding, brewing, filtering before bring a quality & fresh beverage to consumer. The criteria for choosing a method include flavor and economy. Coffee may be brewed by several methods: boiled, steeped, or pressurized. Almost all methods of preparing coffee require the roasted seeds to be ground and mixed with hot water long enough to extract the flavor, but without overextraction that draws out bitter compounds. The spent grounds are removed and the liquid is consumed. There are many brewing variations such as the fineness of grind, the ways in which the water extracts the flavor, manual devices vs. machines, bags vs. filters, additional flavorings (sugar, milk, spices), and spent ground separation techniques etc. In the same temperature stronger water flow, velocity and pressure, extract more flavor and aroma in shorter time such as Expresso.

Most of coffee bean is roasted and ground at a commercial roastery and sold in a batch packaged form that can make many cups, but ground coffee more easy to be oxidized along with finer particle size and longer shelf life. Ground coffee must be stored properly to preserve the fresh taste and aroma of the seed. Ideally, the container must be airtight and kept in a cool area. Once open a bottle, or a can of ground or instant coffee, remain coffee is intend to be oxidized in short time. Deteriorating flavor and losing aroma of batch coffee package make a single-serve package of coffee as a better solution. It is ideal to open one package and have one fresh pod ground for one shot in a short time.

Many shapes of single serve package are used for consumer widely in beverage and food industries such as candy bar, packet, roll, straw, tube etc. Paper, plastic, aluminum, stainless steel are most popular and economic disposable material. Candy stick package is a good container, but they are not intention as a filter and stirring tool. Straw is popular for drinking beverage and stirring, but it not intend to use it as a filter and container. The challenge for having fine holes on straw wall is about wettability if it was used as a filter, small holes prevent wetting and cause weaker water circulation that lowers extraction during a brewing process. For overcoming wetting issues, degree of pressure is applied from inside such as Espresso. All of current products are designed and used for consumer in their purpose normally.

Single served mini plastic cup of ground coffee for machine are becoming popular in recent years because capacity of fresh preservation and personal selections. A typical K-Cup includes a mini filter inside for creating dual functions of a container and a filter, there are not holes on the wall of the cup, there is not a hard handle for mixing. In all these mini cup water is injected from axle hole(s) and overflow from top or bottom. It is abnormal to punch holes on side wall of this kind of cup for current designed applications.

Single packed Coffee bag is not popular as tea bag because floating and weak water circulation prevent extracting flavor from ground coffee in demand time. This kind of gravity-brewing methods depends on dunking bag manually. In a coffee bag there are not big open for injecting water inside and then overflow out, water penetrate into the filter and flow out. It is a challenge to immerse ground coffee in hot water for getting better and quicker soak through without an appropriate method. Some manufactures grind finer, or even add soluble instant coffee in bag for better dip and extraction. Someone suggest longer brewing time. Both of finer particles and longer brewing time will increase bitter and distortion. Someone also argued that a coffee bag is a complete filter, this fine paper filter block oil inside and reduce coffee texture and aroma. A common problem for both tea bag and coffee bag is that a wet paper filter becomes airtight which hold steam and oil inside and increase floating problem. It is impossible to punch bigger holes in upper part of a bag to release oil and foam because there is not a stable upright position, a bag flip and upside down randomly, sediment and ground will dump into cup. Because the defects of coffee bag and tea bag, they are not good enough to make gourmet coffee or steep quality tea beverage.

Rotating a mug or pulling up and down the string of a coffee bag can not reach a strong enough level of water circulation of extracting. A coffee bag string is too soft to control and enforce an intent movement, there is not a stirring movement, there is only dunking. Using a hard body of a spoon, fork, a stick, or a straw can stir a strong water circulation for extracting more flavor and aroma in short time, but these stiff tools can't drive a bag in a controlled way, these external tools need a little extra effort to be found out and cleaned up later after a brewing. Dunking a single mini plastic coffee cup in a mug directly isn't a design intent or practical able. Any prior arts of coffee bag and cup haven't a rigid handle for stirring purpose.

In conclusion, insofar as I am aware, no coffee bag, tea bag, and single coffee cup formerly developed provides a hard porous shell as a handle to a user comfortably holding, and stirring in his mug.

### SUMMARY

Our invention combines a container, a filter, and a stirring tool together in a cylindrical shape and specific arrangement to create a new 3 in 1 Mini Coffee Tube for setting a most upright position during brewing process. A most upright position keeps sediment and coarse particle in bottom, allow coffee oil and foam release from bigger holes in upper part of the filter and the tube. The 3 in 1 mini tube, filter, and mixing tool is a special container with 3 designed functions of containing, filtering, and stirring. A pod of ground coffee will be filled into the 3 in 1 coffee tube and then be wrapped with foil tightly as a single package for single service. It is easy to handle this mini coffee tube to produce strong water circulation pass through ground coffee in a cup. A strong water circulation reduces water contact time, reduce bitter taste. This disposable mini container can be made of light and food safety material such as plastic, paper, fibers, wood, bamboo, aluminum, stainless steel etc. Although ground coffee and wrap foil are most important, they are shown as external elements in our invention. We make a few special arrangements in our invention as below:

a). A thin tube with many holes on the wall for better water pass through. This tube forms a stable cylindrical shape as a main body for other parts depended on, most part of the tube will be immersed into water during a brewing process.

b). A rolled paper filter is supported by the tube against inside or outside wall of the porous tube. Coffee ground will be filled into the filter. The height and width of the filter paper can be adjusted according to requirement.

c). A long and hollow top without or with hole(s) for air exhale or injecting hot water. The top not only plug into the tube as a cover, but also be as a stirring handle. This rigid handle can be forced rotating along with a cup rim, this designed handle makes our mini coffee tube completely different from single coffee bags and single mini plastic coffee cups.

d). A short bottom used to seal lower end of the tube for forming an integrated container.

All of parts forms a close system that contains ground coffee particles inside, will captures sediment and coarse particles inside of the filter during a brewing process, will allows air and water pass through rapidly to extract more flavor and soluble compositions. A tube, a top, and a bottom can be made separately and assembly together, they also can be made in the same process as a vessel or a frame, the goal is to support and hold the filter in a most standing position reliably during a brewing process. A long shape increases contacting surfaces and keeps the tube in most standing position in a cup of water. A most upright operating position allow to open bigger holes in upper part of the rolled filter or the tube for releasing oil and foam without worrying upside down. Sediment will stay at bottom of the coffee tube. The rigid tube is a reliable mixing tool as a spoon. This handle improves controlling of stirring velocity and intensity (force) in a preferred time frame, a stronger water circulation squeezes most compositions and flavor, it significantly increases extracting efficiency. Through reduced height of a rolled filter or punched fine holes in upper part of the filter paper, coffee oil and foam can be released from the tube to make coffee more texture and foam.

Our coffee tube looks has a slender figure like a shape of pen or cigar that profile is better than a short bag or cup. Our single package can be opened just before a brewing process, it has least exposure to air, so that the coffee tube is a better container for gourmet coffee or tea. The coffee tube can be put into a cup similar to a single coffee bag. The coffee tube also can be installed into a special designed coffee machine, hot water inject or drop through the top of the coffee tube. A long hollow top of the coffee tube may be connected with a pipet or a dropper for forcing air and water in and out of the tube. This 3 in 1 disposable coffee tube is a functional & universal container that can be filled with any ground coffee, tea powder, tea leaves, herb, milk powers, coffee mate, sugar, beverage powders etc. The inside installed filter separates coarse particles and sediment from beverage for making a smooth beverage. Our invention can extract more essences than a single disposable coffee bag, it makes coffee brewing or steeping tea simply by reducing external tool such as stick, spoon, and flowing cleaning up.

### DRAWINGS

FIG. 1 is an exploded view of the mini coffee tube without ground coffee and wrapping foil.

FIG. 2 is perspective view of the assembly of coffee tube after taken off wrap foil in an upright position.

### DETAILED DESCRIPTION

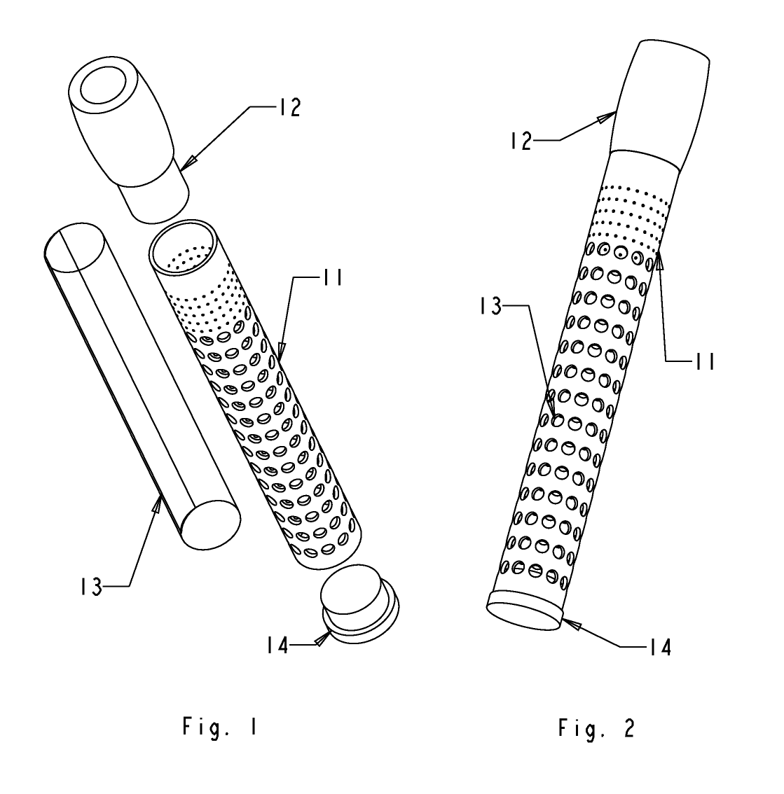

FIG. 1 is an exploded view of a disposable mini coffee tube comprises a porous tube 11, a long top 12, a rolled filter 13, and a short bottom 14 as a complete container that can be used as a filter and mixing tool. The tube 11 is a main structure of the coffee tube, it supports the filter 13 and ground coffee. There are many holes on the wall of the tube 11 for water passing through. The tube 11 is made of light and food safety material such as plastic, paper, fibers, wood, bamboo etc. The tube 11 can be made from different shape of material as sheet, bar, wire, or mesh. The tube 11 is strong enough as a supporting frame and a rigid mixing tool. The bottom 14 will be connected with the tube 11 for forming part of the vessel, it is made of light and food safety material such as plastic, paper, fibers, wood, bamboo etc. The filter 13 is a rolled of filtration material and is supported by the tube 11, ground coffee or tea will be filled inside of the filter 13. The filter 13 is in a long shape, made of light and food safety material such as paper, fibers etc. The top 12 is in a long and hollow shape, there maybe axial hole(s) for air exhale or injecting hot water as demand. The top 12 will be connected with the tube 11 as a cover and hard handle for easy holding and mixing, it is made of light and food safety material such as plastic, paper, fibers, wood, bamboo, aluminum, stainless steel etc.

FIG. 2 is perspective view of the assembly of a coffee tube in a most upright posture during a brewing process. A most upright position will make possible to open bigger holes in the upper middle part of the coffee tube for releasing oil and foam. The size of holes can be similar to metal mesh filter or Espresso porta-filter. The tube 11 and the bottom 14 are put together as an open vessel, the rolled filter 13 is installed into the open vessel and then ground coffee is filled, the top 12 is plugged in the filled vessel for forming a closed container. This ground coffee container named as a coffee tube will be sealed by wrapping foil as a single package for keeping coffee fresh before a single service. The entire coffee tube has multiple functions of containing, filtering, and stirring. User can hold it and stir to produce strong water circulation for extracting more essence and foam in a short fully contacting time.

### REFERENCE NUMBER

11 Tube
12 Top
13 Rolled Filter
14 Bottom

### Operation

The 3 in 1 mini coffee tube comprising a tube, a filter, and a stirring tool acting as a cylindrical container in which ground coffee or tea is pre filled. The 3 in 1 mini coffee tube was filled with ground coffee was sealed by wrapping foil before being made a single fresh coffee beverage. Pull out a wrapped 3 in 1 mini coffee tube from a packet, and then tear off foil:

(1) Put the coffee tube in a cup

(2) Pour water into the cup

(3) Holding the top of the coffee tube to stir a few minutes until extracting enough essences and foam

(4) Taking the coffee tube out of the cup and throwing into a garbage bin

(5) Holding the cup, and drinking coffee beverage

If a user has a special designed coffee machine that is not part of this invention, you will pull out a wrapped 3 in 1 mini coffee tube from a packet, and tear off a wrapping foil:

(1) Open the coffee machine

(2) Install the coffee tube, and place a cup under the machine

(3) Close the coffee machine cover

1. A single disposable mini coffee tube, comprising:
A porous tube which is a main supporting structure to support a filter, and ground coffee alike, and a rolled filter which holds and filters ground coffee or tea, and
a hollow top which is a cover and a hard handle, and
a bottom which connected with the lower end of the tube for forming an integrated container that this entire closed coffee tube has multiple functions of holding, filtering, and stirring tool in a upright position during a brewing process in a cup of water or a coffee machine, spent ground will be stored inside of the coffee tube and thrown away together.
